(19) United States
(12) Patent Application Publication
(10) Pub. No.: US 2015/0106714 A1
(43) Pub. Date: Apr. 16, 2015

(54) ELECTRONIC DEVICE AND METHOD FOR PROVIDING INFORMATION THEREOF

(71) Applicant: Samsung Electronics Co., Ltd., Gyeonggi-do (KR)

(72) Inventors: Jinhong Jeong, Gyeonggi-do (KR); Seungcheol Lee, Seoul (KR); Hyunsoo Kim, Gyeonggi-do (KR); Taegun Park, Gyeonggi-do (KR); Sungho Yoon, Seoul (KR); Kihuk Lee, Gyeonggi-do (KR)

(21) Appl. No.: 14/514,353

(22) Filed: Oct. 14, 2014

(30) Foreign Application Priority Data
Oct. 14, 2013 (KR) 10-2013-0122050

(51) Int. Cl. G06F 3/0481; G06F 3/0488; G06F 3/0484

(52) U.S. Cl. CPC G06F 3/04812; G06F 3/04842; G06F 3/0488
USPC 715/716; 715/856; 715/781; 715/727

(57) ABSTRACT

A method for providing information in an electronic device is provided. The method includes displaying a digital object through a user interface unit. The method also includes acquiring a pointer-over input regarding the digital object. The method further includes identifying attribute of the pointer-over input. The method includes determining information related to the digital object based on the identified attribute. The method also includes offering the determined information through the user interface unit.

### CROSS-REFERENCE TO RELATED APPLICATION(S) AND CLAIM OF PRIORITY

The present application is related to and claims the benefit under 35 U.S.C. §119(a) of a Korean patent application filed on Oct. 14, 2013 in the Korean Intellectual Property Office and assigned Serial No. 10-2013-0122050, the entire disclosure of which is hereby incorporated by reference.

### TECHNICAL FIELD

Various embodiments disclosed herein relate to a method for providing information related to content of a digital object and to an electronic device implementing the method.

### BACKGROUND

Recently electronic devices such as mobile devices have the ability to offer a great variety of services and additional functions. Further, in order to increase the utility of mobile devices and to meet a user's requirement, various applications executable in such mobile devices have been developed in the art.

Nowadays mobile devices having portability and an intuitive user interface unit, such as a smart phone, a mobile phone, a notebook, or a tablet PC, can store therein many applications from at least several applications to hundreds of applications together with associated data. Such applications and data may be displayed in the form of digital objects through a user interface unit of a mobile device. Additionally, these digital objects may be manipulated by means of an input unit such as a user's finger or a stylus pen.

A typical electronic device provides content about a selected digital object and related information in response to an input for selecting the digital object being displayed. For example, in the PC environment, a user can be provided with desired content by selecting a digital object through a mouse as an input unit. Also, by rolling a mouse pointer over a desired digital object, related information may be provided through a preview window. However, since a mouse is absent from a mobile device, alternative technique are required for a mobile device.

### SUMMARY

To address the above-discussed deficiencies, it is a primary object to provide an electronic device and a method for conveniently and intuitively providing various types of information related to a digital object displayed on a user interface unit.

In a first example, a method for providing information in an electronic device is provided. The method includes displaying a digital object through a user interface unit. The method also includes acquiring a pointer-over input regarding the digital object. The method further includes identifying attribute of the pointer-over input. The method includes based on the identified attribute, determining information related to the digital object. The method also includes offering the determined information through the user interface unit.

In a second example, an electronic device is provided. The electronic device includes a user interface unit configured to display a digital object and receive a pointer-over input regarding the digital object. The electronic device also includes a control unit configured to identify attribute of the pointer-over input and determine, based on the identified attribute, information related to the digital object. The control unit is also configured to offer the determined information through the user interface unit.

In a third example, a computer-readable medium including a program recorded thereon is provided. The computer-readable medium including the program recorded thereon is configured to define control commands for displaying a digital object through a user interface unit. The computer-readable medium including the program recorded thereon is also configured to acquire a pointer-over input regarding the digital object; identifying attribute of the pointer-over input. The computer-readable medium including the program recorded thereon is further configured to based on the identified attribute, determine information related to the digital object. The computer-readable medium including the program recorded thereon is configured to offering the determined information through the user interface unit.

In a fourth example, a method implemented by an electronic device is provided. The method includes displaying a digital object related to a media playback through a user interface unit. The method also includes acquiring a pointer-over input regarding the digital object. The method further includes offering information related to the digital object through the user interface unit, based on the attribute of the pointer-over input, wherein the information related to the digital object includes at least one of image information related to media, video or audio information related to at least part of media, and text information related to at least part of media.

In a fifth example, a method implemented by an electronic device is provided. The method includes displaying a digital object related to a media playback through a display. The method also includes acquiring a pointer-over input regarding the digital object. The method further includes in case the pointer-over input has a first attribute, offering at least one of image information, text information and video information, related to media, through the display. The method includes in case the pointer-over input has a second attribute, offering audio information related to at least one of image information, text information and video information through an audio output unit.

In a sixth example, a method implemented by an electronic device is provided. The method includes displaying a digital object through a display. The method also includes acquiring a first pointer-over input regarding the digital object. The method further includes offering first information related to the digital object through a preview window, based on the first pointer-over input. The method includes acquiring a second pointer-over input regarding the preview window. The method includes offering second information related to the digital object through the preview window, based on the second pointer-over input.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example electronic device according to this disclosure.

FIG. 2 is a flow diagram illustrating an example method for providing information of an electronic device according to this disclosure.

FIGS. 3A through 6D are schematic diagrams illustrating an example pointer-over input according to this disclosure.

FIGS. 7A through 7D are screenshots illustrating an example method for providing information in a messenger application according to this disclosure.

FIGS. 8A through 8D are screenshots illustrating an example method for providing information in an image viewer application according to this disclosure.

FIGS. 9A and 9B are screenshots illustrating an example method for providing information in an audio application according to this disclosure.

FIGS. 10A through 10C are screenshots illustrating an example method for providing information in a video application according to this disclosure.

FIGS. 11A and 11B are screenshots illustrating an example method for providing information in an audio application according to this disclosure.

FIG. 12 is a flow diagram illustrating an example method for providing information of an electronic device according to this disclosure.

### DETAILED DESCRIPTION

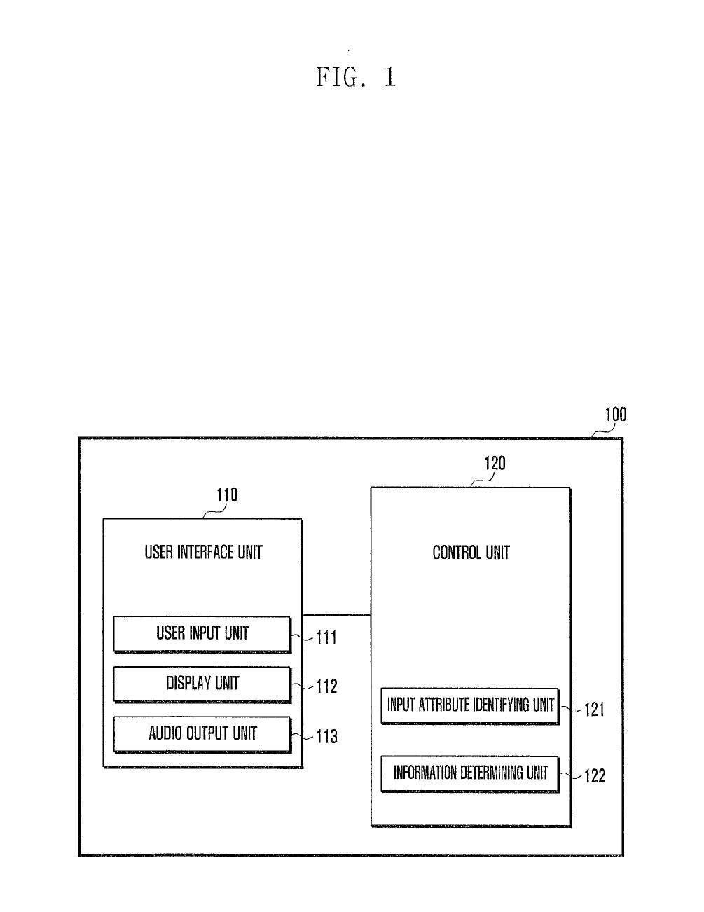

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “an object” includes reference to one or more of such objects.

An electronic device involves a communication function. For example, an electronic device can be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (such as an HMD (Head-Mounted Device) such as electronic glasses, electronic clothes, an electronic bracelet, an electronic necklace, an electronic appcessory, or a smart watch).

An electronic device can be a smart home appliance that involves a communication function. For example, an electronic device can be a TV, a DVD (Digital Video Disk) player, audio equipment, a refrigerator, an air conditioner, a vacuum cleaner, an oven, a microwave, a washing machine, an air cleaner, a set-top box, a TV box (such as Samsung HomeSync™, Apple TV™, Google TV™, and the like), a game console, an electronic dictionary, an electronic key, a camcorder, or an electronic picture frame.

An electronic device can be a medical device (such as MRA (Magnetic Resonance Angiography), MRI (Magnetic Resonance Imaging), CT (Computed Tomography), ultrasonography, and the like), a navigation device, a GPS (Global Positioning System) receiver, an EDR (Event Data Recorder), an FDR (Flight Data Recorder), a car infotainment device, electronic equipment for ship (such as a marine navigation system, a gyrocompass, and the like), avionics, security equipment, or an industrial or home robot.

An electronic device can be furniture or part of a building or construction having a communication function, an electronic board, an electronic signature receiving device, a projector, or various measuring instruments (such as a water meter, an electric meter, a gas meter, a wave meter, and the like). An electronic device disclosed herein can be one of the above-mentioned devices or any combination thereof. As well understood by those skilled in the art, the above-mentioned electronic devices are exemplary only and not to be considered as a limitation of this disclosure.

An electronic device can be designed to recognize an input on, under, over or around a user interface unit thereof, to analyze the recognized input, and to provide a corresponding output through the user interface unit. This input can be entered using a user's finger, a stylus or digital pen, or the like by a user.

FIG. 1 is a block diagram illustrating an example electronic device according to this disclosure.

Referring to FIG. 1, the electronic device 100 includes a user interface unit 110 and a control unit 120.

The user interface unit 110 performs an operation of receiving a user's input and outputting contents provided by the electronic device to a user. For example, the user interface unit 110 includes a touch screen that performs the reception of a touch input and the display of contents at the same time. The user interface unit 110 includes a user input unit 111, a display unit 112, and an audio output unit 113.

The user input unit 111 is a device configured to receive a user's input. For example, the user input unit 111 includes a sensor (such as a touch sensor) that detects a user's input (such as a touch input or a hovering input). The user input unit 111 employs various touch sensing techniques such as a resistive type, a capacitive type, an electromagnetic induction type, a pressure type, or the like. The user input unit 111 includes an eye-gaze input device (such as a camera device) for detecting or acquiring an input through a user's eye-gaze, and a gesture input device (such as an infrared device) for recognizing a user's gesture.

The user input unit 111 detects a proximity input (such as a hovering input) within a given distance as well as a direct touch input from an input device.

The display unit 112 is a device configured to display thereon information outputted by the electronic device. For example, the display unit 112 includes a display panel. When any application is executed, the display unit 112 displays thereon various digital objects.

The audio output unit 113 is a device configured to output an audio signal offered by the electronic device. The audio output unit 113 converts a digital audio signal into an analog audio signal through an audio codec and then reproduces such a signal through a speaker.

The control unit 120 controls an overall operation of the electronic device 100.

The control unit 120 executes a selected application in response to a user's manipulation. This running application includes therein a plurality of digital objects. For example, in case an internet browser application is executed, digital objects such as various image files and text files are contained in a browser.

The control unit 120 identifies information (such as coordinate information of a hovering input) about a specific location indicated or pointed by the input unit or a corresponding location and information (such as altitude information of a hovering input) related to the input unit.

The control unit 120 acquires a pointer-over input regarding a displayed digital object through the user interface unit 110. A pointer-over input refers to, for example, an input of indicating, pointing, or selecting a desired digital object. When a hovering input or touch input on a specific digital object is acquired from the input unit through the user interface unit 110, the control unit 120 recognizes the acquired input as a pointer-over input regarding the digital object. When an eye-gaze input (such as an act to gaze at a specific digital object) is acquired from an eye-gaze sensing module, the control unit 120 recognizes the acquired input as a pointer-over input regarding the digital object. When a gesture input (such as an act to point or grip a specific digital object) is acquired from a gesture sensing module, the control unit 120 recognizes the acquired input as a pointer-over input regarding the digital object. When any input indicating a specific digital object is acquired from a typical pointing device (such as a mouse, a joystick, and the like), the control unit 120 recognizes the acquired input as a pointer-over input regarding the digital object.

When such a pointer-over input regarding a digital object is acquired or received, the control unit 120 identifies the attribute of the pointer-over input. As will be discussed again below, the attribute of the pointer-over input are identified differently depending on input types. Then, based on the attribute of the pointer-over input, the control unit 120 determines information related to content of the digital object to be provided to a user. Therefore, if the attribute of the pointer-over input is changed, information related to content of the digital object or the attribute of such information are changed accordingly. For example, content-related information of a certain digital object includes, but not limited to, at least one of information related to a digital object (such as information about lyrics or musical note of an audio file), summary information about a digital object (such as summary information about an email file), and processed information about a digital object (such as video information with a reduced frame rate of a video file). The attribute of content-related information of a digital object can include, but not limited to, at least one of the resolution of such information, the size of such information, the amount of such information, the output type of such information (such as a popup preview window or an audio output unit), the display direction of such information (such as portrait or landscape), the playback direction of such information (such as forward or backward), the scroll direction of such information (such as horizontal or vertical), the zoom type of such information (such as zoom in or zoom out), and the offering speed of such information (such as 1× or 4×).

The control unit 120 controls the output of the determined information. The control unit 120 controls the display unit 112 to output such information through a preview window. For example, the control unit 120 adjusts the size of a preview window according to the attribute (such as resolution) of the determined information. Additionally, the control unit 120 controls the audio output unit 113 to output such information according to the attribute (such as output type) of the determined information.

Referring to FIG. 1, the control unit 120 includes an input attribute identifying unit 121 and an information determining unit 122.

The input attribute identifying unit 121 is configured to identify the attribute of a pointer-over input regarding a certain digital object. The attribute of a pointer-over input is differently identified depending on the location of a pointer-over input, the number of a pointer-over input, the strength of a pointer-over input, the area of a pointer-over input, the distance between the input unit and the user interface unit, or the like. Further, in case a pen is used as the input unit, the attribute of a pointer-over input is differently identified depending on the status of a pen, such as whether a pen activator (such as a button or dial equipped in the pen) is activated or not, and the movement of a pen, such as whether the pen performs or not a predefined operation (such as a specified gesture). If any pointer-over input is a multi pointer-over input formed of two or more pointer-over inputs, the attribute of the pointer-over input is differently identified depending on the location of each pointer and the distance between adjacent pointers.

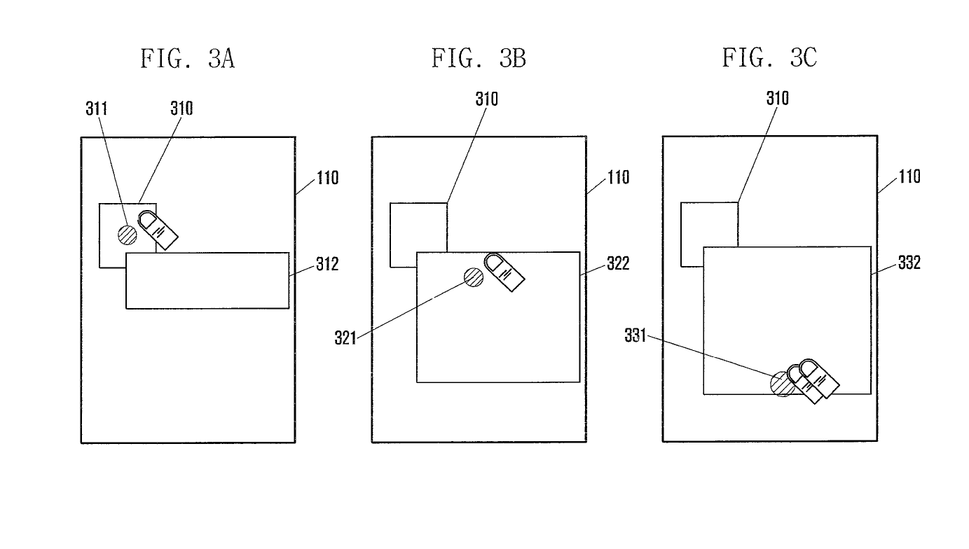

Various embodiments of a pointer-over input will be further described below with reference to FIGS. 3A through 6D.

The information determining unit 122 is configured to determine content-related information of a digital object or the attribute of such information, based on the attribute of a pointer-over input. Depending on types of executing an application, content-related information of a digital object is offered from a network, from a storage unit in the electronic device 100, or through other various routes. Therefore, the information determining unit 122 retrieves content-related information of a digital object from the network, the storage unit, or the like.

The above-discussed configuration of the control unit 120 is exemplary only and not to be considered as a limitation.

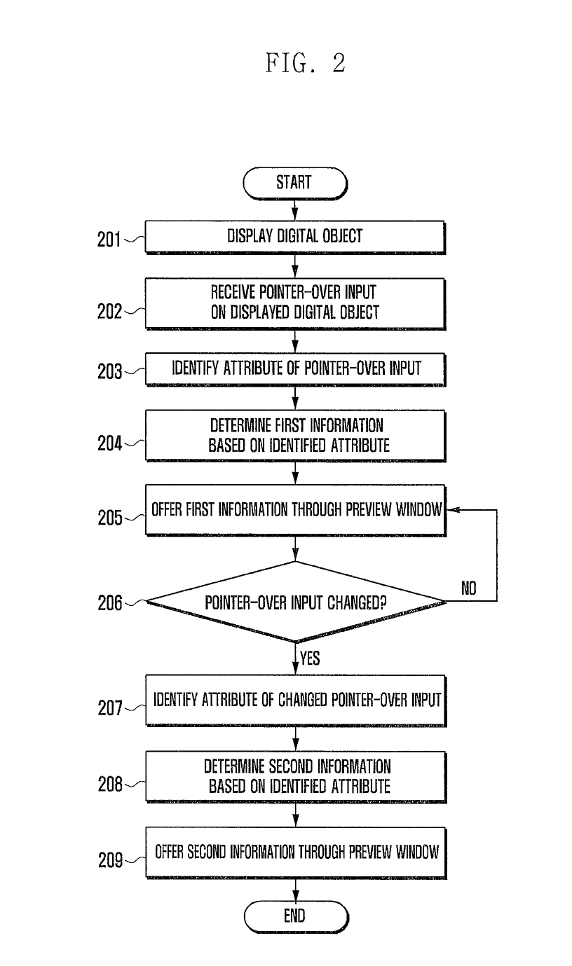

FIG. 2 is a flow diagram illustrating an example method for providing information of an electronic device according to this disclosure.

Referring to FIG. 2, at operation 201, the electronic device 100 displays a digital object on the user interface 110. For example, this digital object can be contained in an idle screen or displayed in response to the execution of various applications.

At operation 202, the electronic device receives a pointer-over input on the displayed digital object. Such a pointer-over input regarding a digital object is entered in various ways by a user. Namely, even though a pointer-over input occurs on the same digital object, a function caused by such an input is differently performed depending on the attribute of the pointer-over input.

At operation 203, the electronic device identifies the attribute of the received pointer-over input. The attribute of a pointer-over input is differently identified depending on the location of a pointer-over input, the number of a pointer-over input, the strength of a pointer-over input, the area of a pointer-over input, the distance between the input unit and the user interface unit, or the like. Further, in case a pen is used as the input unit, the attribute of a pointer-over input is differently identified depending on the status of a pen, such as whether a pen activator (such as a button or dial equipped in the pen) is activated or not, and the movement of a pen, such as whether the pen performs or not a predefined operation (such as a specified gesture). If any pointer-over input is a multi pointer-over input formed of two or more pointer-over inputs, the attribute of the pointer-over input is differently identified depending on the location of each pointer and the distance between adjacent pointers.

Thereafter, at operation 204, the electronic device determines the first information to be provided in connection with content of a digital object, based on the identified attribute. Depending on types of executing an application, the content of a digital object can be offered from a network, from a storage unit in the electronic device 100, or through other various routes. Therefore, the electronic device can retrieve the first information from the network, the storage unit, or the like.

When the first information corresponding to the identified attribute of a pointer-over input is determined, the electronic device outputs at operation 205 the determined first information through the user interface unit (such as a preview window). Depending on the attribute (such as size) of the first information, the size of a preview window is adjusted. Depending on the attribute (such as information type) of the first information, the electronic device outputs the first information through the audio output unit (such as voice signal).

Meanwhile, if any change of a pointer-over input is detected at operation 206, the electronic device may identify again the attribute of the changed pointer-over input at operation 207. A pointer-over input is changed by different attribute with the same digital object unchanged. For example, a change of a pointer-over input occurs in case of desiring to obtain the second information (such as alternative information), being different from the first information, about a specific digital object, or in case of desiring to obtain the second information in addition to the first information. At operation 208, the electronic device determines the second information to be provided in connection with content of a digital object, based on the identified attribute of the changed pointer-over input. The second information can be retrieved from the network, the storage unit, or the like.

When the second information is determined, the electronic device outputs at operation 209 the determined second information through the user interface unit (such as the display unit 112 or the audio output unit 113). In an embodiment, depending on the attribute (such as size or type of information) of the second information, the size of a preview window offered through the display unit 112 can be adjusted.

FIGS. 3A through 6D are schematic diagrams illustrating examples of pointer-over inputs according to this disclosure.

Referring to FIG. 3A, a digital object 310 is displayed on the user interface unit 110, and a pointer-over input 311 (such as a hovering input by a single finer) is received on the digital object 310. The electronic device determines content-related information of the digital object 311 and then outputs it through a preview window 312. As shown, the preview window 312 can be overlaid on the digital object 311.

If a user moves a pointer-over input 321 to the preview window as shown in FIG. 3B, the location attribute of the pointer-over input is changed and hence information or its attribute is also changed. Therefore, the size of a preview window 322 can also be adjusted depending on such information or its attribute. In an embodiment, when the pointer-over input 321 is moved to the preview window, the attribute (such as resolution) of information can be changed and hence preview information, being displayed in FIG. 3A, can be enlarged in FIG. 3B.

If a user increases the strength or area of a pointer-over input 331 as shown in FIG. 3C, the attribute of the pointer-over input is changed again and hence information or its attribute is also changed again. Therefore, the size of a preview window 332 is adjusted again depending on such information or its attribute. In an embodiment, when the strength or area of the pointer-over input 331 is increased, the attribute (such as the amount of information) of information is changed and hence preview information, being displayed in FIG. 3B, is outputted with increasing amount. If the attribute of a pointer-over input is changed, additional or alternative information regarding preview information, being displayed in FIG. 3A, is provided through another preview window in addition to the preview window 312. Also, such additional or alternative information can be provided to the preview window 312.

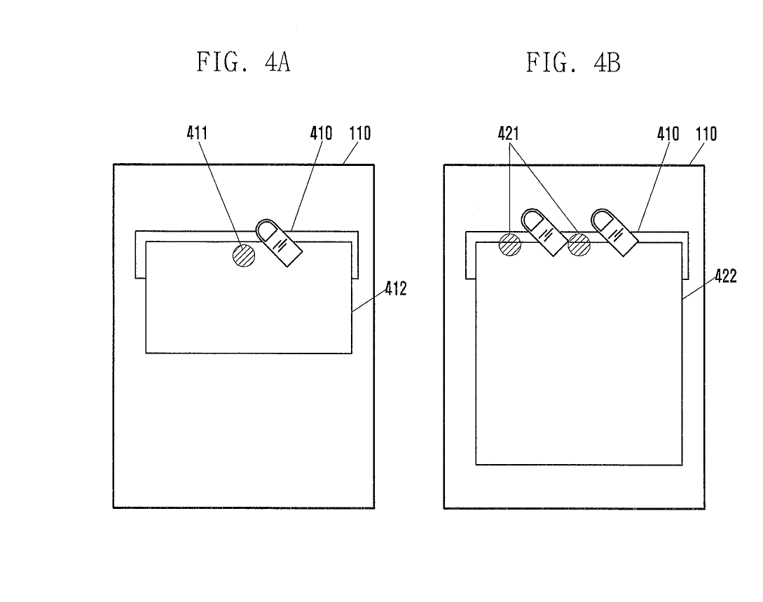

The attribute of a pointer-over input can also be changed depending on the number of pointer-over inputs. Referring to FIG. 4A, a single pointer-over input 411 is received regarding a digital object 410 displayed on the user interface unit 110. At this time, any information determined according to attribute such as the number or location of the single pointer-over input 411 can be outputted through a preview window 412. If the attribute of a pointer-over input is changed to a multi pointer-over input 421 as shown in FIG. 4B, the determined information is changed and hence the size of a preview window 422 is adjusted. In an embodiment, when the attribute of a pointer-over input is changed to the multi pointer-over input 421, any information which replaces preview information, being displayed in FIG. 4A, is outputted. In another embodiment, if the attribute of the multi pointer-over input 421 is changed, additional or alternative information regarding preview information, being displayed in FIG. 4A, is provided through another preview window in addition to the preview window 412. Also, such additional or alternative information can be provided to the preview window 412.

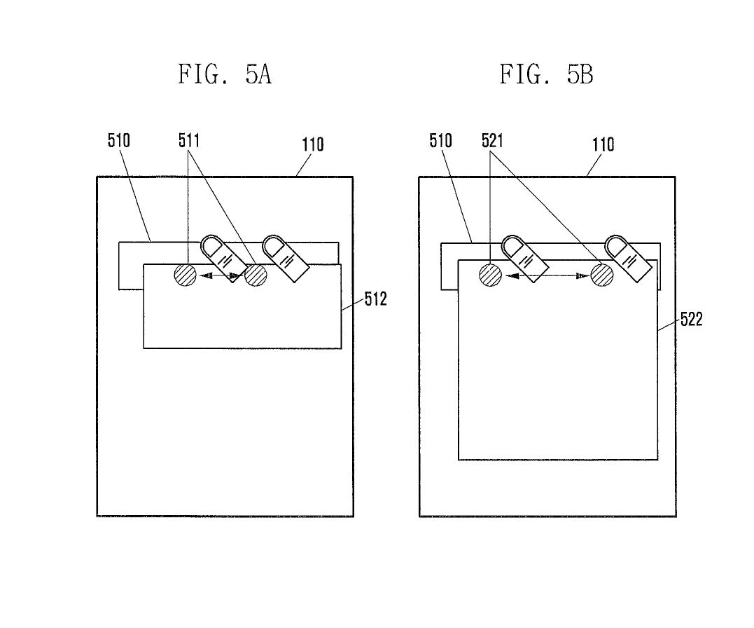

In case of a multi pointer-over input, the attribute of a pointer-over input is changed depending on the distance between respective pointer-over inputs. Referring to FIG. 5A, a multi pointer-over input 511 is received regarding a digital object 510 displayed on the user interface unit 110. This multi pointer-over input 511 has a certain distance between individual pointer-over inputs. Also, any information determined depending on the attribute of the multi pointer-over input 511 is outputted through a preview window 512. Thereafter, if a distance between pointers of a multi pointer-over input 521 is changed as shown in FIG. 5B, the attribute of the pointer-over input is changed and hence the determined information is changed. Therefore, depending on the changed information, the size of a preview window 522 is adjusted. In an embodiment, if a distance between individual pointer-over inputs of the multi pointer-over input 521 is increased, preview information being displayed in FIG. 5A is enlarged.

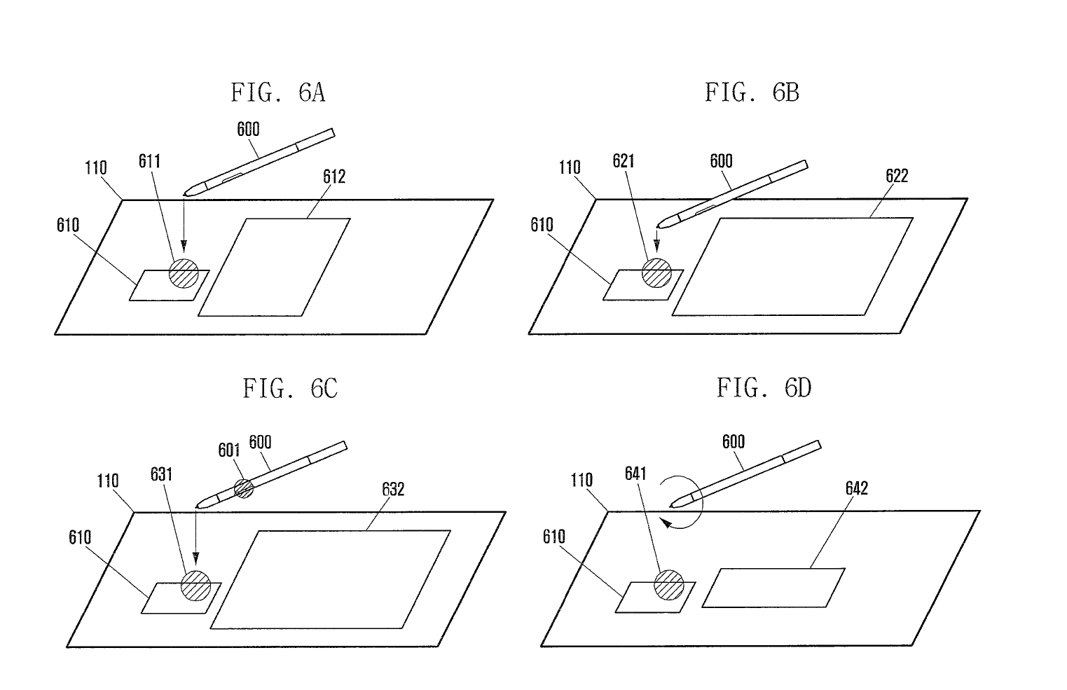

FIGS. 6A through 6D shows various changes in an example pointer-over input on the user interface unit according to this disclosure.

Referring to FIG. 6A, a pointer-over input 611 is received through a pen 600 on a digital object 610 displayed on the user interface unit 110, and also the first information determined therefrom is outputted through a preview window 612. The pointer-over input 611 has the distance attribute defined from the pen 600 to the user interface unit 110. Thereafter, if the distance between the pen 600 and the user interface unit 110 is changed as shown in FIG. 6B, the attribute of a pointer-over input is also changed and hence the determined information is changed to the second information. Further, depending on the attribute of the second information, the size of a preview window 622 is adjusted. In an embodiment, if the distance between the pen 600 and the user interface unit 110 is reduced, preview information being displayed in FIG. 6A is enlarged or increased.

Meanwhile, as shown in FIG. 6C, the pen 600 includes therein an activator 601, and in this case the attribute of a pointer-over input is changed depending on whether the activator 601 is activated or not. Namely, if the activator 601 is changed to an activated state, the attribute of a pointer-over input 631 is changed and hence the determined information is changed to the third information. Further, the size of a preview window 632 is adjusted depending on the attribute of the third information. If the third information is additional information regarding the second information, the window size is unchanged. In an embodiment, when the activator 601 of the pen 600 is activated, the third information is added to the second information being displayed in an inactivated state of the activator 601.

The attribute of a pointer-over input can also be changed by the movement of the pen (such as a gesture). Referring to FIG. 6D, when the pen 600 is rotated, a pointer-over input 641 has the attribute of a certain movement path. In response to this change of attribute, the determined information is changed to the fourth information and then outputted through a preview window 642.

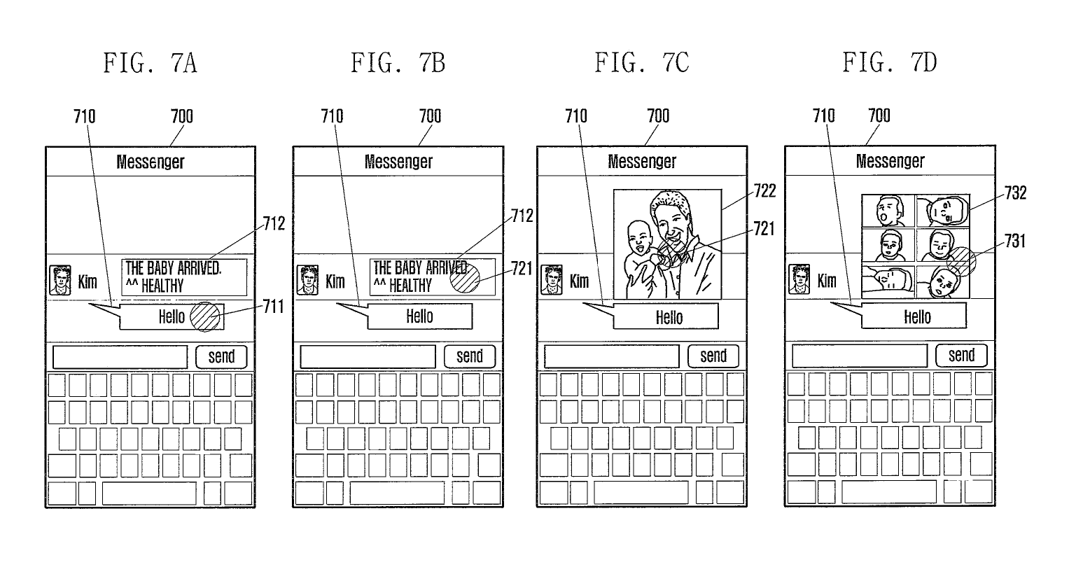

FIGS. 7A through 7D are a screenshot illustrating an example method for providing information in a messenger application according to this disclosure.

If a user triggers a messenger application, the messenger application 700 is offered on the user interface unit. In case a pointer-over input 711 having the first attribute is received on a chatting message 710 of a chatting partner as shown in FIG. 7A, the first information related to the chatting message 710 (such as information related to a chatting partner) is displayed through a preview window 712. Then if a pointer-over input 721 is moved to the preview window 712 as shown in FIG. 7B, the electronic device recognizes that the attribute of a pointer-over input is changed to the second attribute, and hence output the second information (such as information about a chatting partner) through a preview window 722 as shown in FIG. 7C. Thereafter, if a pointer-over input 731 is moved to the boundary of a preview window 732 as shown in FIG. 7D, the electronic device recognizes that the attribute of a pointer-over input is changed to the third attribute, and hence output the third information (such as several pieces of photo information) through the preview window 732 (such as containing several preview sub-windows).

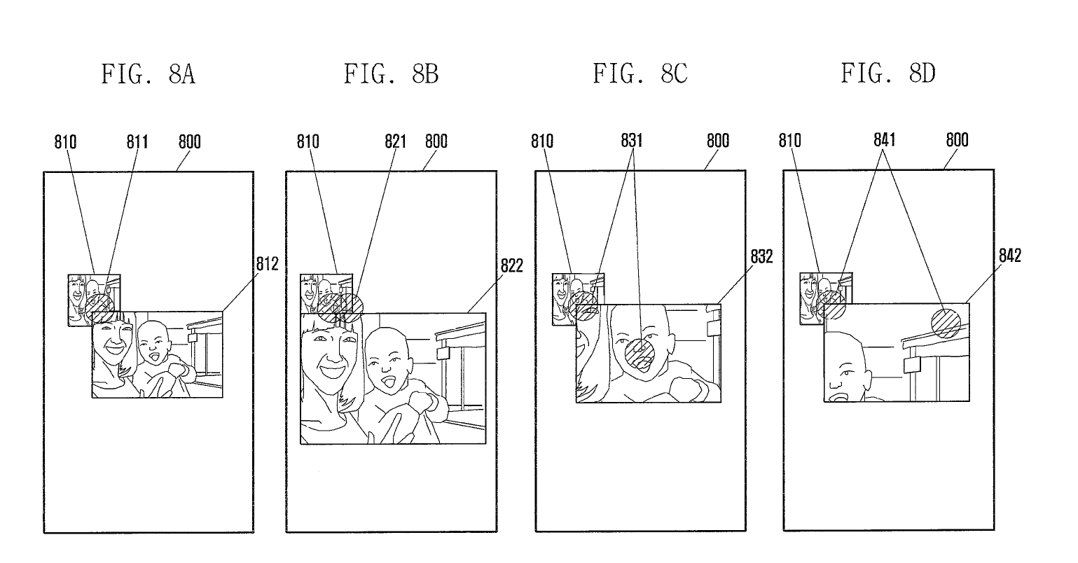

FIGS. 8A through 8D are screenshots illustrating an example method for providing information in an image viewer application according to this disclosure.

If a user triggers an image viewer application (such as a gallery application), the image viewer application 800 is offered on the user interface unit. In case a pointer-over input 811 is received on a certain image 810, as shown in FIG. 8A, information enlarging the image 810 or high-resolution image information is offered through a preview window 812. In case the strength or area of a pointer-over input 821 is increased as shown in FIG. 8B, the electronic device changes the attribute of information and then offers further enlarged image information through a preview window 822. In case a multi pointer-over input 831 or 841 is entered into both the digital object 810 and a preview window 832 or 842 as shown in FIG. 8C or FIG. 8D, the electronic device can select a specific image region to be enlarged from an image file, depending on the location of a pointer-over input entered into the preview window 832 or 842.

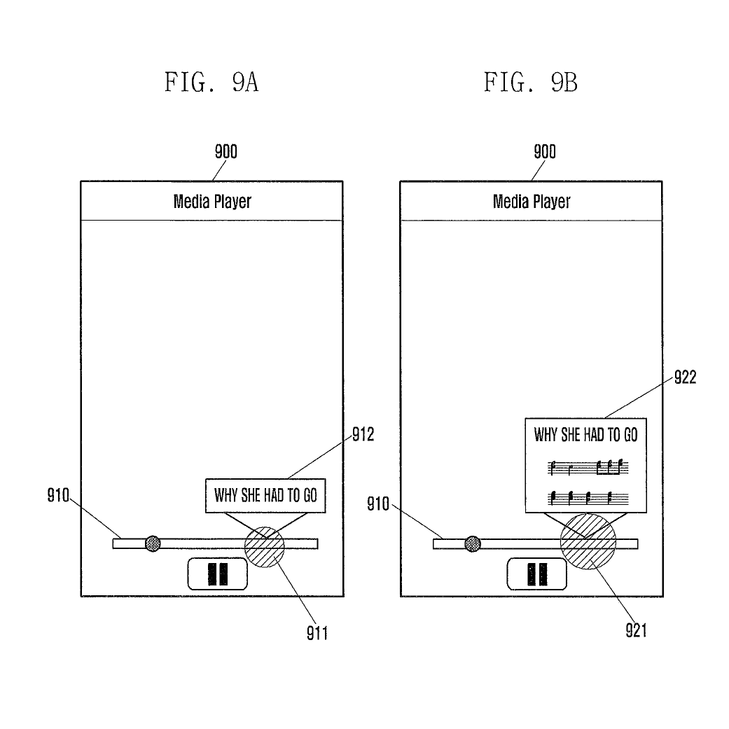

FIGS. 9A and 9B are screenshots illustrating an example method for providing information in an audio application according to this disclosure.

If a user triggers an audio application, the audio application 900 is offered on the user interface unit. If a pointer-over input 911 is received on a specific point of a progress bar 910 as shown in FIG. 9A, any information (such as lyrics information) corresponding to the specific point is offered through a preview window 912. In an embodiment, if the attribute of a pointer-over input 921 is changed (such as the strength or area is increased) as shown in FIG. 9B, any information (such as musical note) corresponding to the specific point is offered additionally or alternatively through a preview window 922. In another embodiment, if the attribute of the pointer-over input 921 is changed (such as the strength or area is increased) as shown in FIG. 9B, any information (such as audio corresponding to the specific point) related to the specific point is outputted through the audio output unit 113.

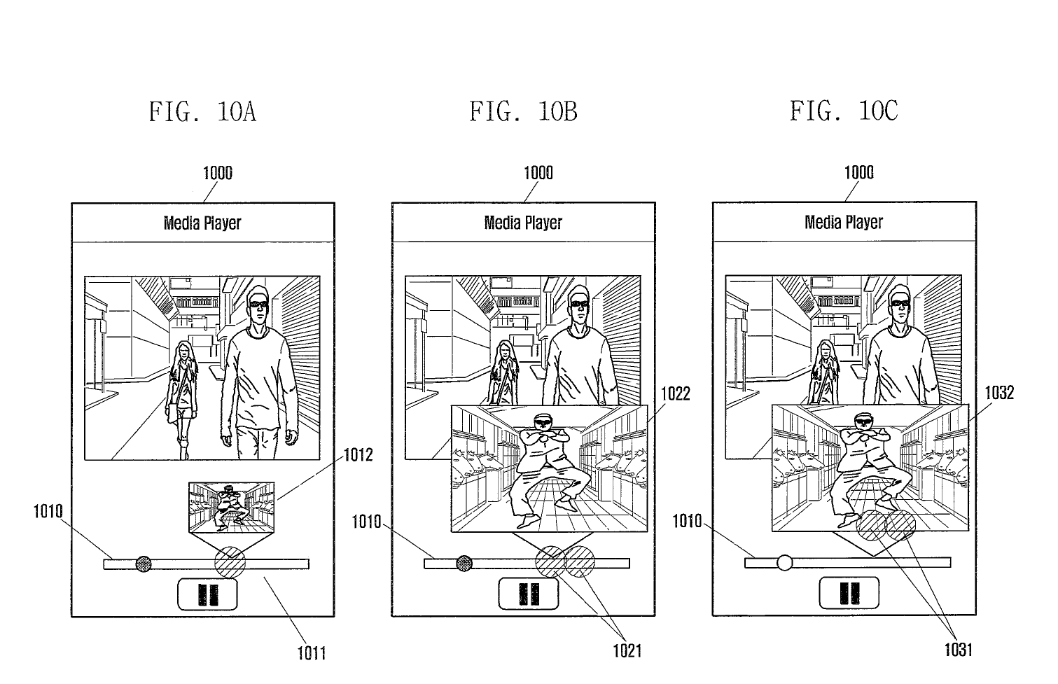

FIGS. 10A through 10C are screenshots illustrating an example method for providing information in a video application according to this disclosure.

When a user triggers a video application, the video application 1000 is offered on the user interface unit. If a pointer-over input 1011 is received on a specific point of a progress bar 1010 as shown in FIG. 10A, any information corresponding to the specific point can be offered through a preview window 1012. This information can be image information or video information. In the latter case, if the video application is playing no video file, an audio part of preview video information is offered through the audio output unit 113. In contrast, if the video application is playing a certain video file, no audio part is offered.

If the strength or area of a pointer-over input 1021 is increased as shown in FIG. 10B, video information corresponding to the specific point is offered through a preview window 1022 by being enlarged or with high resolution. Thereafter, when a pointer-over input 1031 is moved to a preview window 1032 as shown in FIG. 10C, and in case image information has been offered through the existing preview window 1022, the electronic device starts to offer video information instead of image information through the preview window 1032 from the specific point. Alternatively, based on the attribute of the pointer-over input, the electronic device can offer additional information tagged with video information through the preview window 1032. Alternatively, based on the attribute of the pointer-over input, the electronic device offers an audio part of preview video information through the audio output unit 113. In an embodiment, depending on the attribute of the pointer-over input, such video information is offered with different playback speed or direction.

A method for providing information, implemented by an electronic device (such as the electronic device 100), includes an operation of displaying a digital object (such as the progress bar 910 or 1010) related to a media playback through a user interface unit, an operation of acquiring a pointer-over input regarding the digital object, and an operation of offering information related to the digital object through the user interface unit based on the attribute of the pointer-over input. The information related to the digital object can include at least one of image information related to media, video or audio information related to at least part of media, and text information (such as lyrics information or tag information) related to at least part of media.

A method for providing information, implemented by an electronic device (such as the electronic device 100), includes operation of displaying a digital object (such as the progress bar 1010) related to a media playback through a display (such as the display unit 112), an operation of acquiring a pointer-over input regarding the digital object, an operation of offering at least one of image information, text information and video information, related to media, through another display (such as the preview window 1022) in case the pointer-over input has the first attribute, and an operation of offering audio information related to at least one of image information, text information and video information through an audio output unit in case the pointer-over input has the second attribute.

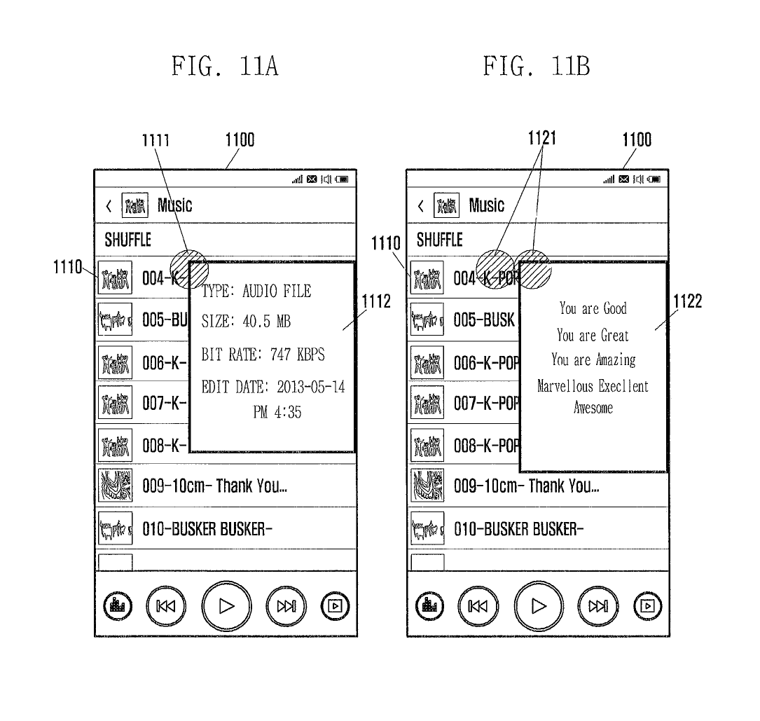

FIGS. 11A and 11B are screenshots illustrating an example method for providing information in an audio application according to this disclosure.

When a user opens a playback list of an audio application, an audio playback list 1100 is offered on the user interface unit. If a pointer-over input 1111 is received on a selected audio file 1110 in the audio playback list 1100 as shown in FIG. 11A, any related information, such as a file type, a file size, a bit rate, an edit date, and the like, of the selected audio file can be offered through a preview window 1112. If the strength or area of a pointer-over input 1121 is increased as shown in FIG. 11B, lyrics information of the selected audio file 1110 can be alternatively offered through a preview window 1122.

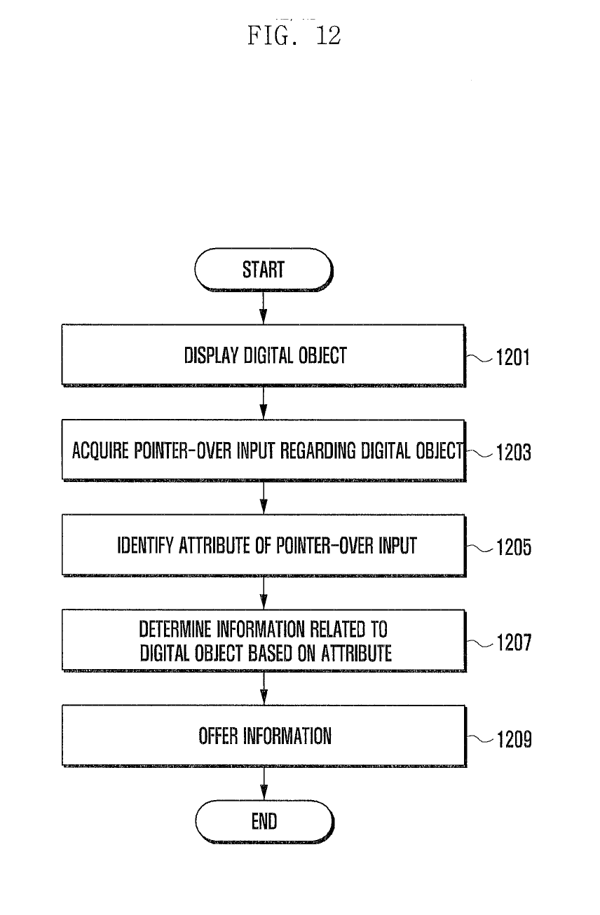

FIG. 12 is a flow diagram illustrating an example method for providing information of an electronic device according to this disclosure.

Referring to FIG. 12, at operation 1201, an electronic device (such as the electronic device 100) displays a digital object through a user interface unit (such as the user interface unit 110) which is functionally connected thereto. At operation 1203, the electronic device acquires a pointer-over input regarding the displayed digital object. This pointer-over input can include an input of indicating, pointing, or selecting the digital object.

At operation 1205, the electronic device may identify the attribute of the pointer-over input. In an embodiment, the attribute of the pointer-over input can include, but not limited to, at least one of the location, number, strength, area of the pointer-over input, the distance between the input unit and the user interface unit, the status of the input unit, and the operation of the input unit. In case the pointer-over input is a multi pointer-over input, the attribute of the pointer-over input further includes the location of each pointer-over input and the distance between the respective pointer-over inputs.

At operation 1207, the electronic device determines information related to the digital object, based on the identified attribute. In an embodiment, this operation of determining information can include operation of determining at least one of the resolution, size, amount, output type, display direction, playback direction, scroll direction, zoom type, and offering speed of such information.

At operation 1209, the electronic device offers the determined information through the user interface unit. In an embodiment, such information is offered through a preview window on the user interface unit. This preview window is offered with different sizes depending on the attribute of information.

According to an embodiment, the method for providing information includes operation of detecting a change of a pointer-over input, operation of determining additional or alternative information related to a digital object on the basis of the attribute of the changed pointer-over input, and operation of offering the determined additional or alternative information through the user interface unit.

Depending on the attribute of a pointer-over input as well as a displayed digital object selected by the pointer-over input, various types of related information are offered to a user through a preview window during the execution of various applications in the electronic device.

Since specific information to be provided is determined depending on the attribute of a pointer-over input received on a digital object, a user can conveniently obtain information related to a digital object through a simple manipulation.

disclosuredisclosureAlthough the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing information in an electronic device, the method comprising:
displaying a digital object through a user interface unit;
acquiring a pointer-over input regarding the digital object;
identifying attribute of the pointer-over input;
determining information related to the digital object based on the identified attribute; and
offering the determined information through the user interface unit.

2. The method of claim 1, wherein the attribute of the pointer-over input includes at least one of a location, number, strength, area of the pointer-over input, a distance between an input unit and the user interface unit, a status of the input unit, and operation of the input unit, and wherein when the pointer-over input is a multi pointer-over input, the attribute of the pointer-over input further includes a location of each pointer-over input and a distance between the respective pointer-over inputs.

3. The method of claim 1, wherein determining the information includes determining at least one of a resolution, size, amount, output type, display direction, playback direction, scroll direction, zoom type, and offering speed of the information.

4. The method of claim 1, wherein determining the information includes retrieving the information from a network or a storage unit.

5. The method of claim 1, wherein offering the determined information includes offering the information through a preview window on the user interface unit or outputting the information through an audio output unit in the user interface unit.

6. The method of claim 1, wherein offering the determined information includes offering the information through a preview window having different sizes depending on attribute of the information.

7. The method of claim 1, further comprising:
detecting a change of the pointer-over input;
determining additional or alternative information related to the digital object based on attribute of the changed pointer-over input; and
offering the additional or alternative information through the user interface unit.

8. The method of claim 7, wherein the additional or alternative information is offered through a created preview window.

9. The method of claim 8, wherein the created preview window has different sizes depending on attribute of the additional or alternative information.

10. An electronic device comprising:
a user interface unit configured to display a digital object and receive a pointer-over input regarding the digital object; and
a control unit configured to identify attribute of the pointer-over input, determine, based on the identified attribute, information related to the digital object, and offer the determined information through the user interface unit.

11. The electronic device of claim 10, wherein the attribute of the pointer-over input includes at least one of a location, number, strength, area of the pointer-over input, a distance between an input unit and the user interface unit, a status of the input unit, and operation of the input unit, and wherein when the pointer-over input is a multi pointer-over input, the attribute of the pointer-over input further includes a location of each pointer-over input and a distance between the respective pointer-over inputs.

12. The electronic device of claim 10, wherein the control unit is further configured to retrieve the information from a network or a storage unit so as to determine the information, based on the identified attribute, and to either offer the determined information through a preview window on the user interface unit or output the information through an audio output unit in the user interface unit.

13. The electronic device of claim 12, wherein the control unit is further configured to adjust a size of the preview window depending on attribute of the information.

14. The electronic device of claim 10, wherein the control unit is further configured to acquire a change of the received pointer-over input, identify attribute of the changed pointer-over input, determine additional or alternative information related to the digital object, based on the identified attribute of the changed pointer-over input, and offer the additional or alternative information through the user interface unit.

15. A computer-readable medium including a program recorded thereon configured to:
display a digital object through a user interface unit;
acquire a pointer-over input regarding the digital object;
identify attribute of the pointer-over input;
determine information related to the digital object based on the identified attribute; and
offer the determined information through the user interface unit.

16. A method implemented by an electronic device, comprising:
displaying a digital object related to a media playback through a user interface unit;
acquiring a pointer-over input regarding the digital object; and
offering information related to the digital object through the user interface unit based on the attribute of the pointer-over input,
wherein the information related to the digital object includes at least one of image information related to media, video or audio information related to at least part of media, and text information related to at least part of media.

17. A method implemented by an electronic device, comprising:
displaying a digital object related to a media playback through a display;
acquiring a pointer-over input regarding the digital object;
in case the pointer-over input has a first attribute, offering at least one of image information, text information and video information, related to media, through the display; and
when the pointer-over input has a second attribute, offering audio information related to at least one of image information, text information and video information through an audio output unit.

18. A method implemented by an electronic device, comprising:
displaying a digital object through a display;
acquiring a first pointer-over input regarding the digital object;
offering first information related to the digital object through a preview window based on the first pointer-over input;
acquiring a second pointer-over input regarding the preview window; and
offering second information related to the digital object through the preview window based on the second pointer-over input.

19. The method of claim 18, wherein the first or second information is offered through the preview window having changed attribute depending on attribute of the first or second information.

20. The method of claim 18, wherein the first pointer-over input is equal to the second pointer-over input.
